(19) United States
(12) Patent Application Publication
(10) Pub. No.: US 2008/0185167 A1
(43) Pub. Date: Aug. 7, 2008

(54) FLAT CABLE AND ELECTRONIC APPLIANCE HAVING THE SAME

(75) Inventor: Jai-Yool LEE, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/938,969

(22) Filed: Nov. 13, 2007

(30) Foreign Application Priority Data
Feb. 6, 2007 (KR) 2007-0012154

(51) Int. Cl. H01B 7/08

(52) U.S. Cl. 174/117 F

(57) ABSTRACT

A flat cable and an electronic appliance having the same. The flat cable includes a first signal transmission layer including a first insulating member, and a plurality of first ground lines and a plurality of first signal lines embedded in a row within the first insulating member, a second signal transmission layer including a second insulating member, and a plurality of second ground lines and a plurality of second signal lines embedded in a row within the second insulating member, and an insulating layer interposed between the first signal transmission layer and the second signal transmission layer. The first and second signal transmission layers are coupled with both sides of the insulating layer, respectively, to face each other, each of the first ground lines and each of the second ground lines are arranged to face each other, and each of the first signal lines and each of the second signal lines are arranged to face each other. A strong electromagnetic field is formed between each first signal line and each second signal line, so that signals can be transmitted stably through the first and second signal lines.

### CROSS-REFERENCE TO RELATED APPLICATIONS

This application claims the benefit of Korean Patent Application No. 2007-0012154, filed on Feb. 6, 2007 in the Korean Intellectual Property Office, the disclosure of which is incorporated herein by reference in its entirety.

### BACKGROUND OF THE INVENTION

1. Field of the Invention

The present general inventive concept relates to a flat cable, and, more particularly, to a flat cable which is connected between two electronic components to transfer signals therebetween, and an electronic appliance having the same.

2. Description of the Related Art

Recently, digital products, such as home appliances including digital televisions and digital versatile disc (DVD) players, office supplies including copy machines, printers, facsimiles and scanners, and various types of computing devices, have been actively introduced to the market, and various researches have been done for improving the performances of these digital products.

The entire performances of digital products are dependent on various factors including hardware performance and software performance. Data signal transmission/reception performance also has a great effect on the performances of digital products. The data signal transmission/reception performance is dependent on how rapidly a data signal is transmitted with no distortion from a data transmitter to a data receiver.

There have been developed various schemes for transmitting and receiving data signals, and a low voltage differential signaling (LVDS) scheme, among them, has recently been widely used. The LVDS scheme is a data communication technology in which, when transmitting a data signal, a data transmitter transmits the original signal and an inverted signal thereof together, and a data receiver detects the difference between the transmitted two signals and restores the original signal based on the detected difference.

In order to transmit and receive a data signal in the LVDS scheme, it is necessary to interconnect, via a signal transmission cable, two electronic components transmitting and receiving the data signal. Recently, a flexible flat cable (FFC) has been widely used as the signal transmission cable. This flat cable is thin and easily deformable, so that it is suitable for the latest, small and thin digital products and usefully used in digital products with mobile data transmitters, such as scanners, copy machines and ink-jet printers.

Typically, the flat cable includes an insulating member made of an insulating material such as polyester, and a plurality of thin conductors embedded in the insulating member. In this flat cable, a desired signal arrives at the output end of the cable with an electromagnetic field formed by adjacent conductors. The strength of the electromagnetic field has a great effect on the signal transmission.

FIG. 1 is a schematic sectional view of a conventional flat cable which is used in a scanner to interconnect an image sensor and a main board in the scanner.

As illustrated in FIG. 1, the conventional flat cable, denoted by reference numeral 10, includes a thin insulating member 11, and a plurality of ground lines 12 and a plurality of signal lines 13 and 14 provided within the insulating member 11. The signal lines 13 and 14 are classified into positive signal lines 13 for transmission of positive signals and negative signal lines 14 for transmission of negative signals. These ground lines 12 and signal lines 13 and 14 are arranged in a row in the order of ground line 12, positive signal line 13, negative signal line 14 and ground line 12.

However, in the conventional flat cable 10 with this single-layer structure, an electromagnetic field represented by “e” is formed within a narrow range between each positive signal line 13 and each negative signal line 14, as illustrated in FIG. 1. For this reason, provided that the cable 10 is longer, more severe distortion will occur at the output end of the cable 10.

For example, assume that the flat cable 10 is 750 mm long and a low voltage differential signal of 100 MHz is transmitted using the flat cable 10. In this case, as illustrated in a graph of FIG. 2, each positive signal and each negative signal at the output end of the cable 10 exhibit unstable waveforms, and the differential signal at the output end, which is the difference between the two signals, exhibits an unstable waveform, too. For this reason, there is a problem that these signals are very vulnerable to external noise and subject to distortion.

In addition, the conventional flat cable 10 has pins arranged in a row at each of both ends thereof. For this reason, provided that the number of pins of the cable 10 increases, the width of the cable 10 will increase. As a result, the number of pins is limited, resulting in a limitation in increasing the amount of data to be transmitted.

### SUMMARY OF THE INVENTION

The present general inventive concept provides a flat cable which is capable of being minimally influenced by external noise, transmitting a data signal stably without distortion and increasing the amount of data to be transmitted, and an electronic appliance having the same.

Additional aspects and/or utilities of the present general inventive concept will be set forth in part in the description which follows and, in part, will be obvious from the description, or may be learned by practice thereof.

The foregoing and/or other aspects and utilities of the general inventive concept may be achieved by providing a flat cable including: a first signal transmission layer including a first insulating member, and a plurality of first ground lines and a plurality of first signal lines embedded in a row within the first insulating member; a second signal transmission layer including a second insulating member, and a plurality of second ground lines and a plurality of second signal lines embedded in a row within the second insulating member; and an insulating layer interposed between the first signal transmission layer and the second signal transmission layer, wherein the first and second signal transmission layers are coupled with both sides of the insulating layer, respectively, to face each other, each of the first ground lines and each of the second ground lines are arranged to face each other, and each of the first signal lines and each of the second signal lines are arranged to face each other.

The plurality of first ground lines and the plurality of first signal lines may be arranged in a row in such a manner that two of the first ground lines are disposed at both sides of one of the first signal lines, respectively, and the plurality of second ground lines and the plurality of second signal lines may be arranged in a row in such a manner that two of the second ground lines are disposed at both sides of one of the second signal lines, respectively.

The first signal lines may be positive signal lines to transmit positive signals, and the second signal lines may be negative signal lines to transmit negative signals.

Alternatively, the first signal lines may be negative signal lines to transmit negative signals, and the second signal lines may be positive signal lines to transmit positive signals.

The first pin parts may be provided at both ends of the first signal transmission layer, respectively, the first pin parts including externally exposed ends of the first ground lines and first signal lines, and second pin parts may be provided at both ends of the second signal transmission layer, respectively, the second pin parts including externally exposed ends of the second ground lines and second signal lines.

The foregoing and/or other aspects and utilities of the general inventive concept may also be achieved by providing an electronic appliance including: a first electronic component; a second electronic component to transmit and receive signals to/from the first electronic component; and a flat cable to interconnect the first and second electronic components to enable the signals to be transmitted and received between the first and second electronic components, wherein the flat cable includes: a first signal transmission layer including a first insulating member, and a plurality of first ground lines and a plurality of first signal lines embedded in a row within the first insulating member; a second signal transmission layer including a second insulating member, and a plurality of second ground lines and a plurality of second signal lines embedded in a row within the second insulating member; and an insulating layer interposed between the first signal transmission layer and the second signal transmission layer, wherein the first and second signal transmission layers are coupled with both sides of the insulating layer, respectively, to face each other, each of the first ground lines and each of the second ground lines are arranged to face each other, and each of the first signal lines and each of the second signal lines are arranged to face each other.

The foregoing and/or other aspects and utilities of the general inventive concept may also be achieved by providing a flat cable to connect two electrical components, including a first insulating member including a first group of ground lines and signal lines disposed therein; a second insulating member including a second group of ground lines and signal lines disposed therein; and an insulating layer disposed between the first insulating member and the second insulating member, the insulating member having an adhesive property to adhere to a side of each of the first insulating layer and the second insulating layer and having a thickness such that a differential impedance of the flat cable is the same as that of the two electrical components in which the flat cable connects.

The first and second insulating members can be adhered to the insulating member such that the first and second ground lines face each other and the first and second signal lines face each other.

The flat cable may further include first pin parts provided at both ends of the first insulating member and including externally exposed ends of the first ground lines and the first signal lines; and second pin part provided at both ends of the second insulating member and including externally exposed ends of the second ground lines and the second signal lines.

The flat cable may further include a connector member to removably connect one side thereof to an end of the flat cable and to removably connect another side thereof the corresponding electronic component, the connector member including: a connector body to connect with a corresponding electronic component; a plurality of first terminals provided in the connector body to correspond to a corresponding one of the first pin parts; and a plurality of second terminals provided in the connector body to correspond to a corresponding one of the second pin parts.

The connector member may further include a coupling slit provided at a center thereof to receive the corresponding end of the flat cable, wherein the plurality of first terminals are arranged in a row at one side of the coupling slit to protrude from that side and the plurality of second terminals are arranged in a row at another side of the coupling slit to extend therefrom and face the first terminals.

### BRIEF DESCRIPTION OF THE DRAWINGS

These and/or other aspects and utilities of the general inventive concept will become apparent and more readily appreciated from the following description of the embodiments, taken in conjunction with the accompanying drawings of which:

FIG. 1 is a schematic sectional view of a conventional flat cable;

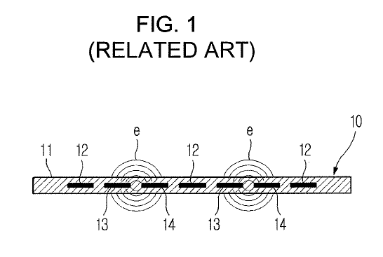

FIG. 2 is a graph illustrating waveforms of signals transmitted through the conventional flat cable;

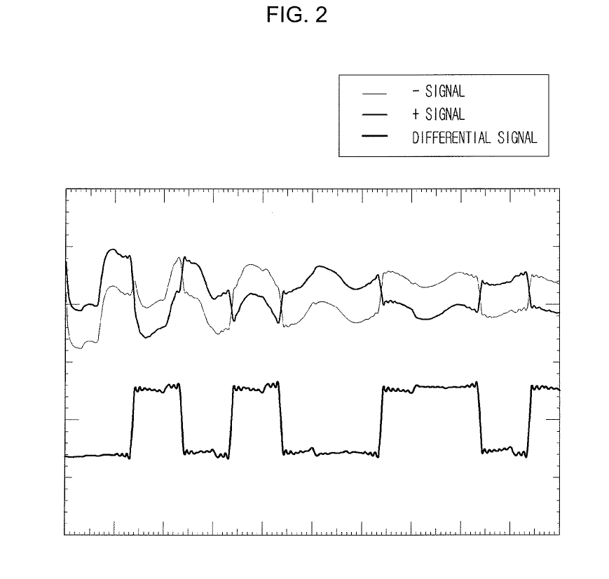

FIG. 3 is a schematic side view of an electronic appliance with a flat cable according to an exemplary embodiment of the present general inventive concept;

FIG. 4 is a schematic perspective view of the flat cable according to the embodiment of FIG. 3;

FIG. 5 is a sectional view of the flat cable according to the embodiment of FIG. 3;

FIG. 6 is a graph illustrating waveforms of signals transmitted through the flat cable according to the embodiment of FIG. 3;

FIG. 7 is a schematic plan view of a connector with which the flat cable according to the embodiment of FIG. 3 is coupled; and

FIG. 8 is a schematic plan view of a connector coupler with which the connector illustrated in FIG. 7 is coupled.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

A flat cable and an electronic appliance having the same according to an exemplary embodiment of the present general inventive concept will hereinafter be described with reference to the accompanying drawings.

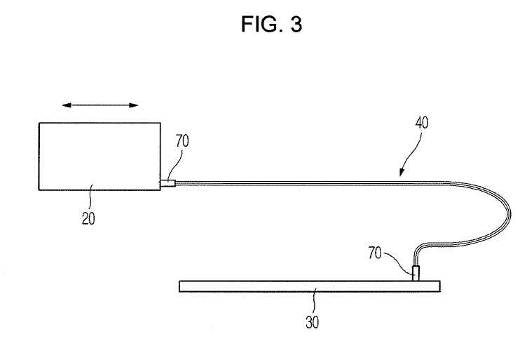

As illustrated in FIG. 3, the electronic appliance with the flat cable according to the present embodiment includes a first electronic component 20 including an image sensor (not illustrated) and acting to read an image while reciprocally moving, and a second electronic component 30 to receive an image signal transmitted from the first electronic component 20. The first and second electronic components 20 and 30 are interconnected via a flat cable 40, which is flexible. Here, the first and second electronic components 20 and 30 transmit and receive signals in a low voltage differential signaling (LVDS) scheme.

The flat cable 40 interconnects the first electronic component 20 and the second electronic component 30 so that signals can be transmitted between those electronic components 20 and 30. Connectors 70 are coupled with the first electronic component 20 and the second electronic component 30, respectively, to connect the flat cable 40 between those electronic components 20 and 30.

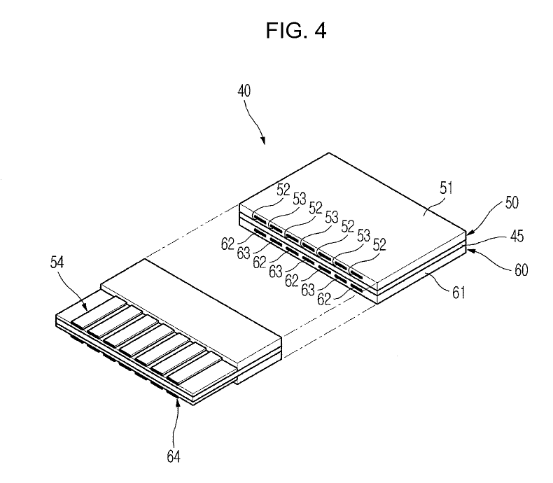

The flat cable 40 includes, as illustrated in FIG. 4, first and second signal transmission layers 50 and 60 to provide signal transmission, and an insulating layer 45 interposed between the first signal transmission layer 50 and the second signal transmission layer 60.

The first signal transmission layer 50 includes a first insulating member 51, and a plurality of first ground lines 52 and a plurality of first signal lines 53 embedded in a row within the first insulating member 51. The first insulating member 51 can be made of an insulating material such as polyester. The first ground lines 52 and the first signal lines 53 can be made of thin conductors inserted within the first insulating member 51. Each of the first ground lines 52 and each of the first signal lines 53 are paired and spaced apart from each other by a predetermined distance.

Here, the first signal lines 53 are positive signal lines to provide transmission of positive signals. The plurality of first ground lines 52 and the plurality of first signal lines 53 are arranged in a row in such a manner that two of the first ground lines 52 is disposed at each side of the first signal lines 53.

Although four first ground lines 52 and three first signal lines 53 are illustrated in FIG. 4 to be present within the first insulating member 51, it will be understood that the present general inventive concept is not limited thereto, and the number of first ground lines 52 and the number of first signal lines 53 may be diversely modified.

Respectively provided at both ends of the first signal transmission layer 50 are first pin parts 54 including externally exposed ends of the first ground lines 52 and first signal lines 53. These first pin parts 54 are inserted into the connectors 70, which are coupled with the first electronic component 20 and the second electronic component 30.

The second signal transmission layer 60 has the same structure as that of the first signal transmission layer 50. That is, the second signal transmission layer 60 includes a second insulating member 61, and a plurality of second ground lines 62 and a plurality of second signal lines 63 embedded in a row within the second insulating member 61. The plurality of second ground lines 62 and the plurality of second signal lines 63 are arranged in a row in such a manner that one of the second ground lines 62 is disposed at each side of the second signal lines 63, respectively. Here, the second signal lines 63 are negative signal lines to provide transmission of negative signals. The second ground lines 62 are the same in number as the first ground lines 52 of the first signal transmission layer 50 and the second signal lines 63 are the same in number as the first signal lines 53 of the first signal transmission layer 50.

Respectively provided at both ends of the second signal transmission layer 60 are second pin parts 64 corresponding to the first pin parts 54 of the first signal transmission layer 50. These second pin parts 64 include externally exposed ends of the second ground lines 62 and second signal lines 63. Together with the first pin parts 54, the second pin parts 64 are inserted into the connectors 70, respectively, which are provided in both the first electronic component 20 and the second electronic component 30. By inserting the first pin parts 54 and the second pin parts 64 into the connectors 70, an electrical connection is made between the first electronic component 20 and the second electronic component 30 via the flat cable 40.

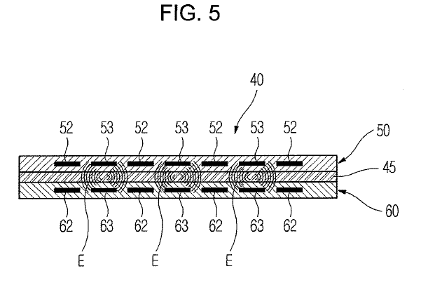

The first and second signal transmission layers 50 and 60 face each other while having the insulating layer 45 disposed therebetween, as illustrated in FIGS. 4 and 5. Here, each of the first ground lines 52 and each of the second ground lines 62 are also arranged to face each other, and each of the first signal lines 53 and each of the second signal lines 63 are also arranged to face each other.

As an alternative, negative signals may be transmitted over the first signal lines 53 of the first signal transmission layer 50, and positive signals may be transmitted over the second signal lines 63 of the second signal transmission layer 60 facing the first signal lines 53.

The insulating layer 45 has an adhesive property and is interposed between the first and second signal transmission layers 50 and 60. This insulating layer 45 is made of an insulating material such as polyester. The insulating layer 45 has a thickness properly set such that the differential impedance of the flat cable 40 is the same as that of the first and second electronic components 20 and 30. As well known in the art, the dielectric constant of the insulating layer 45 is importantly considered in setting the thickness of the insulating layer 45.

In the flat cable 40 with the above-stated configuration according to the present embodiment, when positive and negative signals are transmitted over the first and second signal lines 53 and 63, respectively, a strong electromagnetic field E is formed between each first signal line 53 and each second signal line 63, as illustrated in FIG. 5. As a result, even though the cable 40 is longer, the signals can be transmitted clearly without distortion through the first and second signal lines 53 and 63.

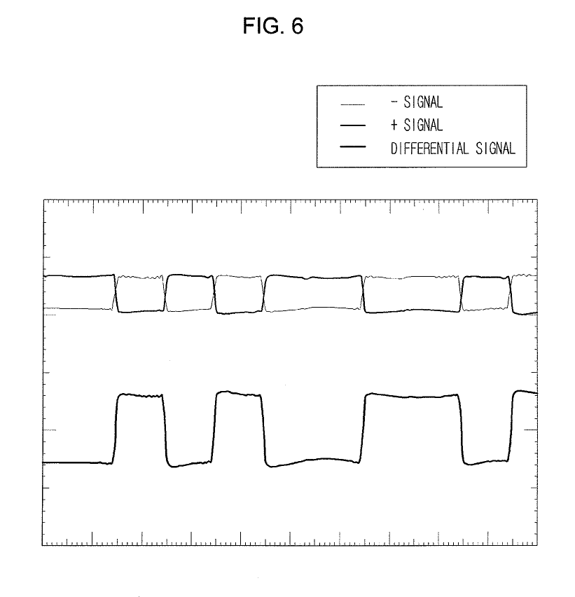

For example, assume that the flat cable 40 of the present embodiment is 750 mm long and a low voltage differential signal of 100 MHz is transmitted using the flat cable 40. In this case, as illustrated in a graph of FIG. 6, each positive signal and each negative signal at the output end of the cable 40 exhibit stable waveforms, and the differential signal at the output end, which is the difference between the two signals, exhibits a stable waveform, too. Therefore, signals can be transmitted stably without distortion while being minimally influenced by external noise.

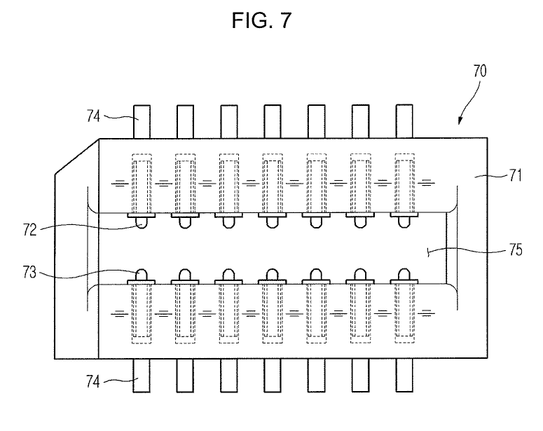

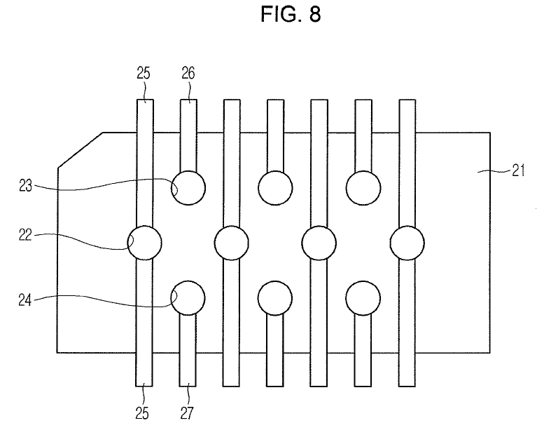

FIG. 7 illustrates the connectors 70 which are coupled with the first electronic component 20 and the second electronic component 30, respectively, to connect the flat cable 40 between those electronic components 20 and 30, and FIG. 8 illustrates connector couplers 21 which are provided in the first and second electronic components 20 and 30 so as to be coupled with the connectors 70, respectively.

As illustrated in FIG. 7, each connector 70 includes a connector body 71 coupled with a corresponding one of the first and second electronic components 20 and 30, a plurality of first terminals 72 provided in the connector body 71 to correspond to a corresponding one of the first pin parts 54 of the flat cable 40, a plurality of second terminals 73 provided in the connector body 71 to correspond to a corresponding one of the second pin parts 64 of the flat cable 40, and a plurality of terminal connection members 74 connected with the first and second terminals 72 and 73, respectively. The first and second terminals 72 and 73 and the terminal connection members 74 are made of conductive materials capable of transmitting electric signals.

A coupling slit 75 is provided at the center of the connector body 71 to receive the corresponding end of the flat cable 40. The plurality of first terminals 72 are arranged in a row at one side of the coupling slit 75 to protrude from that side, and the plurality of second terminals 73 are arranged in a row at the other side of the coupling slit 75 to face the first terminals 72 and protrude from that side.

When the corresponding end of the flat cable 40 is inserted into the coupling slit 75 of the connector body 71, the first ground lines 52 and first signal lines 53 of the corresponding first pin part 54 come into contact with the first terminals 72, respectively, and the second ground lines 62 and second signal lines 63 of the corresponding second pin part 64 come into contact with the second terminals 73, respectively. As a result, electrical connections are made between the first ground lines 52 and first signal lines 53 of the first pin part 54 and the first terminals 72, and electrical connections are made between the second ground lines 62 and second signal lines 63 of the second pin part 64 and the second terminals 73.

As illustrated in FIG. 8, a plurality of via holes 22, 23 and 24 are provided in each of the connector couplers 21 of the first and second electronic components 20 and 30 with which the connectors 70 are coupled. Ground connection lines 25 and first and second signal connection lines 26 and 27 provided in each of the first and second electronic components 20 and 30 are connected with the first and second ground lines 52 and 62 and the first and second signal lines 53 and 63 of the flat cable 40 through the via holes 22, 23 and 24, respectively.

When each connector 70 is coupled with the corresponding connector coupler 21, the via holes 22, 23 and 24 are completely covered by the connector body 71.

On the other hand, the above-described electronic appliance may be, for example, a scanner in which the first electronic component 20 is movable, the second electronic component 30 is fixed and the first and second electronic components 20 and 30 are interconnected via the flat cable 40, and the present general inventive concept is not limited thereto. It will be understood that the present general inventive concept is applicable to any electronic appliances other than the scanner in which at least two electronic components transmitting and receiving signals are provided and interconnected via the flat cable.

As is apparent from the above description, according to the present general inventive concept, each first signal line that transmits a positive signal and each second signal line that transmits a negative signal are arranged to face each other while being spaced apart from each other at a predetermined distance. As a result, when the positive and negative signals are transmitted over the first and second signal lines, respectively, a strong electromagnetic field is formed between the first signal line and the second signal line. Consequently, the signals can be transmitted clearly without distortion while being minimally influenced by external noise.

Further, because signal lines transmitting signals are formed in two layers, an upper layer and a lower layer, it is possible to increase the amount of data to be transmitted and the number of signal lines without a need to increase the width of a cable.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A flat cable comprising:
a first signal transmission layer including a first insulating member, and a plurality of first ground lines and a plurality of first signal lines embedded in a row within the first insulating member;
a second signal transmission layer including a second insulating member, and a plurality of second ground lines and a plurality of second signal lines embedded in a row within the second insulating member; and
an insulating layer interposed between the first signal transmission layer and the second signal transmission layer,
wherein the first and second signal transmission layers are coupled with both sides of the insulating layer, respectively, to face each other, each of the first ground lines and each of the second ground lines are arranged to face each other, and each of the first signal lines and each of the second signal lines are arranged to face each other.

2. The flat cable according to claim 1, wherein the plurality of first ground lines and the plurality of first signal lines are arranged in a row in such a manner that two of the first ground lines are disposed at both sides of one of the first signal lines, respectively, and the plurality of second ground lines and the plurality of second signal lines are arranged in a row in such a manner that two of the second ground lines are disposed at both sides of one of the second signal lines, respectively.

3. The flat cable according to claim 2, wherein the first signal lines are positive signal lines to transmit positive signals, and the second signal lines are negative signal lines to transmit negative signals.

4. The flat cable according to claim 2, wherein the first signal lines are negative signal lines to transmit negative signals, and the second signal lines are positive signal lines to transmit positive signals.

5. The flat cable according to claim 2, wherein first pin parts are provided at both ends of the first signal transmission layer, respectively, the first pin parts including externally exposed ends of the first ground lines and first signal lines, and second pin parts are provided at both ends of the second signal transmission layer, respectively, the second pin parts including externally exposed ends of the second ground lines and second signal lines.

6. An electronic appliance comprising:
a first electronic component;
a second electronic component to transmit and receive signals to/from the first electronic component; and
a flat cable to interconnect the first and second electronic components to enable the signals to be transmitted and received between the first and second electronic components,
wherein the flat cable includes:
a first signal transmission layer including a first insulating member, and a plurality of first ground lines and a plurality of first signal lines embedded in a row within the first insulating member;
a second signal transmission layer including a second insulating member, and a plurality of second ground lines and a plurality of second signal lines embedded in a row within the second insulating member; and
an insulating layer interposed between the first signal transmission layer and the second signal transmission layer,
wherein the first and second signal transmission layers are coupled with both sides of the insulating layer, respectively, to face each other, each of the first ground lines and each of the second ground lines are arranged to face each other, and each of the first signal lines and each of the second signal lines are arranged to face each other.

7. The electronic appliance according to claim 6, wherein the plurality of first ground lines and the plurality of first signal lines are arranged in a row in such a manner that two of the first ground lines are disposed at both sides of one of the first signal lines, respectively, and the plurality of second ground lines and the plurality of second signal lines are arranged in a row in such a manner that two of the second ground lines are disposed at both sides of one of the second signal lines, respectively.

8. The electronic appliance according to claim 7, wherein the first signal lines are positive signal lines to transmit positive signals, and the second signal lines are negative signal lines to transmit negative signals.

9. The electronic appliance according to claim 7, wherein the first signal lines are negative signal lines to transmit negative signals, and the second signal lines are positive signal lines to transmit positive signals.

10. The electronic appliance according to claim 7, wherein first pin parts are provided at both ends of the first signal transmission layer, respectively, the first pin parts including externally exposed ends of the first ground lines and first signal lines, and second pin parts are provided at both ends of the second signal transmission layer, respectively, the second pin parts including externally exposed ends of the second ground lines and second signal lines.

11. The electronic appliance according to claim 10, wherein a connector is provided in the first and/or second electronic component so as to be coupled with the flat cable, the connector including a connector body having a slit to receive the flat cable, a plurality of first terminals installed in the slit to correspond to a corresponding one of the first pin parts, and a plurality of second terminals installed in the slit to correspond to a corresponding one of the second pin parts and face the first terminals.

12. The electronic appliance according to claim 11, wherein a plurality of terminal connection members are provided in the connector body to be connected with the first and second terminals, respectively, and a connector coupler is provided in the first and/or second electronic component to be coupled with the connector, the connector coupler having a plurality of via holes which are connected with the terminal connection members, respectively, when being covered by the connector body.

13. A flat cable to connect two electrical components, comprising:
a first insulating member including a first group of ground lines and signal lines disposed therein;
a second insulating member including a second group of ground lines and signal lines disposed therein; and
an insulating layer disposed between the first insulating member and the second insulating member, the insulating layer having an adhesive property to adhere to a side of each of the first insulating member and the second insulating member and having a thickness such that a differential impedance of the flat cable is the same as that of the two electrical components in which the flat cable connects.

14. The flat cable according to claim 13, wherein the first and second insulating members are adhered to the insulating layer such that the first and second ground lines face each other and the first and second signal lines face each other.

15. The flat cable according to claim 14, further comprising:
first pin parts provided at both ends of the first insulating member and including externally exposed ends of the first ground lines and the first signal lines; and
second pin part provided at both ends of the second insulating member and including externally exposed ends of the second ground lines and the second signal lines.

16. The flat cable according to claim 15, further comprising:
a connector member to removably connect one side thereof to an end of the flat cable and to removably connect another side thereof the corresponding electronic component, the connector member including:
a connector body to connect with a corresponding electronic component;
a plurality of first terminals provided in the connector body to correspond to a corresponding one of the first pin parts; and
a plurality of second terminals provided in the connector body to correspond to a corresponding one of the second pin parts.

17. The flat cable according to claim 16, wherein the connector member further comprises:
a coupling slit provided at a center thereof to receive the corresponding end of the flat cable, wherein the plurality of first terminals are arranged in a row at one side of the coupling slit to protrude from that side and the plurality of second terminals are arranged in a row at another side of the coupling slit to extend therefrom and face the first terminals.
